(19) United States
(12) Patent Application Publication
(10) Pub. No.: US 2013/0218593 A1
(43) Pub. Date: Aug. 22, 2013

(54) USAGE OF ASSIGNED TREATMENT IN CLINICAL DECISION SUPPORT SYSTEMS

(71) Applicants: Boaz Carmeli, Koranit (IL); Carmel Kent, Zippori (IL); Yonatan Maman, Hof Hacarmel (IL); Ruty Rinott, Jerusalem (IL); Yoav Rubin, Haifa (IL); Noam Slonim, Jerusalem (IL)

(72) Inventors: Boaz Carmeli, Koranit (IL); Carmel Kent, Zippori (IL); Yonatan Maman, Hof Hacarmel (IL); Ruty Rinott, Jerusalem (IL); Yoav Rubin, Haifa (IL); Noam Slonim, Jerusalem (IL)

(73) Assignee: INTERNATIONAL BUSINESS MACHINES CORPORATION, Armonk, NY (US)

(21) Appl. No.: 13/400,071

(22) Filed: Feb. 19, 2012

(51) Int. Cl. G06Q 50/24

(52) U.S. Cl. 705/3

(57) ABSTRACT

A computer-implemented method and apparatus for receiving a multiplicity of medical cases associated with a disease, each of the multiplicity of medical cases comprising medical features and assigned treatment, wherein the medical cases are divided into two or more groups such that each of groups is associated with a treatment assigned to medical cases classified into the group; and using the multiplicity of medical cases as divided into the two or more groups, to determine information.

### TECHNICAL FIELD

The present disclosure relates to clinical decision support systems in general, and to the usage of assigned treatment as the target for clinical decision support systems, in particular.

### BACKGROUND

A Clinical Decision Support System (CDSS or CDS) is a decision support system (DSS), which is designed to assist physicians and other health professionals with decision-making tasks, such as assigning treatment for a patient. A clinical decision support system may be looked at as a knowledge system, which uses two or more items of personal or medical data to provide medical case-specific advice.

CDSS may be used to assist clinicians at the point of care to achieve diagnostic or assign treatment to their patient, and thus help improve patient care. CDSS may also be used by health institutes for further research and evaluation of diagnostics and assigned treatments.

Existing CDS tools typically rely on rules, deduced from relevant clinical guidelines. Health Care Organizations (HCOs) adopt electronic health record technologies that may use clinical data collected and stored at the HCO. Some of the tools use Machine Learning (ML) techniques to predict the outcome of optional treatments, based on outcomes recorded in the HCO, and recommend the treatment with the best outcome. However, this goal poses many problems. In many cases the outcome information is not available, e.g., in cases where the outcome is unknown or can be determined only long after the treatment was given. In addition, determining what is the “best outcome” is typically not trivial, as the outcome could be composed of many factors, such as full or partial recovery, survival, treatment side affects, etc.

In view of the above, there is required a CDSS that may overcome the deficiencies of existing systems.

### BRIEF SUMMARY

One exemplary embodiment of the disclosed subject matter is a computer-implemented method performed by a computerized device, comprising: receiving a multiplicity of medical cases associated with a disease, each of the multiplicity of medical cases comprising medical features and assigned treatment, wherein the medical cases are divided into two or more groups such that each of the groups is associated with a treatment assigned to medical cases classified into the group; and using the multiplicity of medical cases as divided into the groups, to determine information.

Another aspect of the disclosed subject matter is an apparatus having a processing unit and a storage device, the apparatus comprising: a storage device storing a multiplicity of medical cases associated with a disease, each of the multiplicity of medical cases comprising medical features and assigned treatment, wherein the medical cases are divided into two or more groups such that each of the groups is associated with a treatment assigned to medical cases classified into the group.

Yet another aspect of the disclosed subject matter is a computer program product comprising: a non-transitory computer readable medium; a first program instruction for receiving a multiplicity of medical cases associated with a disease, each of the multiplicity of medical cases comprising medical features and assigned treatment, wherein the medical cases are divided into two or more groups such that each of the groups is associated with a treatment assigned to medical cases classified into the group; and a second program instruction for using the multiplicity of medical cases as divided into the groups, to determine information, wherein said first and second program instructions are stored on said non-transitory computer readable medium.

### BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a graph of retrospective treatment analysis, in accordance with some exemplary embodiments of the disclosed subject matter;

FIG. 2 shows a flow chart of steps in a method for using a clinical decision support system, in accordance with some exemplary embodiments of the disclosed subject matter; and

FIG. 3 shows a block diagram of components of an apparatus for clinical decision support, in accordance with some exemplary embodiments of the disclosed subject matter.

### DETAILED DESCRIPTION

The disclosed subject matter is described below with reference to flowchart illustrations and/or block diagrams of methods, apparatus (systems) and computer program products according to embodiments of the subject matter. It will be understood that blocks of the flowchart illustrations and/or block diagrams, and combinations of blocks in the flowchart illustrations and/or block diagrams, can be implemented by computer program instructions. These computer program instructions may be provided to one or more processors of a general purpose computer, special purpose computer, a processor, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transient computer-readable medium that can direct a computer or other programmable data processing apparatus to function in a particular manner, such that the instructions stored in the non-transient computer-readable medium produce an article of manufacture including instruction means which implement the function/act specified in the flowchart and/or block diagram block or blocks.

The computer program instructions may also be loaded onto a device. A computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

One technical problem dealt with by the disclosed subject matter is the insufficiency or inadequacy of information provided by currently existing CDS systems. Currently available systems focus on the classical paradigm of predicting the outcome of assigning a particular treatment given a medical situation. Thus, given a collection of medical and personal data, the physician is presented with possible treatments and their expected outcomes. However, providing the outcomes of different treatments may suffer from a number of deficiencies: the outcome may not always be known or available, and it may not always be conclusive as a number of factors may be considered, such as full or partial curing, survival, side effects, or the like. Yet another technical problem relates to the outcomes possibly being biased due to the fact that treatments are not randomly assigned. Thus sicker patients might be more likely to receive a certain treatment, which may cause this treatment to appear as resulting in bad outcomes.

One technical solution comprises the collection and compilation of a HCO database which focuses on the assigned treatment rather than on the outcome of the treatment. The proposed method and apparatus may be used in the context of a particular disease, denoted for example by d. The method and apparatus may mine the HCO database for all patients diagnosed with disease d and treated accordingly, and for which the assigned treatment is recorded in the HCO database. In some embodiments, the HCO database may be constructed as a matrix, in which each row is associated with a patient and each column is associated with a feature or detail, such as age, gender, physical or medical measure, result of a particular medical test or the like. One feature or column may be associated with the treatment assigned to the patient for treating disease d.

The collection of cases may be divided into classes or groups, and the groups may be labeled according to the provided treatment, such that the cases for which a particular treatment was assigned may be associated with that class. The grouping may be used as training data for generating a classifier which may be used for classifying a case to one of the classes and thus determine the suggested treatment. The training may comprise determination of feature ranking, weights, or other criteria or characteristics upon which it is determined with which class a particular case is to be associated.

In some embodiments the labeled database and trained classifier can be used for a variety of usages, including providing a physician with recommendation for treatment for a particular patient, based on treatment provided in other similar cases. In some embodiments, the labeled database and trained classifier may be researched by the health organization or institute in order to reveal factors that are of high importance in determining treatments, factors that are of low importance and may be eliminated if associated with high expenses or risks for the patient or the environment, or the like.

One technical effect of the disclosed subject matter may relate to given a case of a patient with a particular disease, the case consisting of a given set of personal, demographic, or medical data, the method and apparatus can be used for suggesting the treatment assigned to similar cases to a case.

In some embodiments, a multiplicity of assigned treatments may be presented along with their distribution, or with differentiating factors. For example, if the age of the patient is not provided, the system may present that in cases in which the patient was under forty years old, treatment A was provided, while in other cases treatment B was preferred. In some embodiments the system may further indicate a feature or a collection of features that may contribute to the decision to suggest the best treatment. In some cases, the system may provide the assigned treatment only after receiving the suggestion made by the physician, and can thus provide a “second opinion” for the physician, by providing an answer to the question of what other physicians would have assigned to this case. The physician can then consider the provided suggestion and optional reasoning before taking a decision regarding the assigned treatment.

Another technical effect of the disclosed subject matter relates to using the database with the assigned treatment for retrospective treatment analysis, for example in order to provide, enhance, or refine treatment guidelines. HCO management or senior physicians can explore the database and inspect off-line the HCO treatment allocation process. In some embodiments, the system may explore the correlation between a particular feature, such as the result of an expensive test, and the assigned treatment. If the result of this test had little or no influence on the assigned treatment, then the significance of performing the test may be questioned. In another example, if there is very high correlation between the results of a particular test and the assigned treatment, it may be added to the guidelines that this test should be performed prior to deciding on a treatment.

Yet another technical effect of the disclosed subject matter relates to a person known to suffer from a disease, exploring the database or reporting his personal and medical details and receiving a “second opinion” indicating what other physicians would have assigned.

Referring now to Table 1, showing a database of medical health records associated with a particular disease, represented as a table.

TABLE 1

| | | Blood | Heart | Blood | |
|---|---|---|---|---|---|
| Age | Gender | Pressure | Rate | Type | Treatment |
| 25 | F | 60 | 100 | A+ | none |
| 45 | M | 60 | 120 | AB− | Monotherapy |
| 63 | M | 80 | 78 | A− | Combination |
| 51 | F | 90 | 60 | O+ | Monotherapy |
| 28 | M | 110 | 75 | O+ | none |

Each patient is represented by a row, and each feature is represented by a column. Thus, each entry comprises a particular detail of a patient. The table may include one or more columns related to personal features such as age or gender, one or more columns related to medical features such as symptoms, test results, or the like, and one or more columns related to features associated with a treatment received by the patient. Additional features may relate to the treatment result. It will be appreciated that a table is merely an exemplary data structure or representation, and any other data structures or representations comprising or accessing the required features may be used.

The database, arranged as a table or any other data structure, may be classified according to the treatment feature. In the example of Table 1, one class will be created which includes the second and the fourth rows in which monotherapy was provided, a second class which includes the third row in which a combined treatment was provided, and a third class which includes the first and fifth row in which no treatment was provided.

When a caregiver such as a physician has to treat a patient having a disease, the physician inputs into an apparatus in accordance with the disclosure the patient details, including for example the details appearing in Table 1, including the patient's age, gender, blood pressure, heart rate and blood type. The apparatus then associates the details with one of the classes created for that disease, in accordance with some measure, such as a metric defined between cases, or between a case and a class, and provides the treatment associated with the cases of this class. The treatment suggested by the system may thus provide the physician with an answer to the question of what other physicians would have determined for a patient having similar features. In some embodiments, in order to prevent bias, the apparatus may provide the treatment only after the physician has entered the treatment he or she thinks is most appropriate under the particular circumstances. In some embodiments, the system may further provide an explanation, e.g., a feature which has the most influence on the provided treatment. In the example of Table 1, the selection of the provided treatment is clearly due to the patient's age, so the system will present that the specific treatment was suggested due to the patient's age.

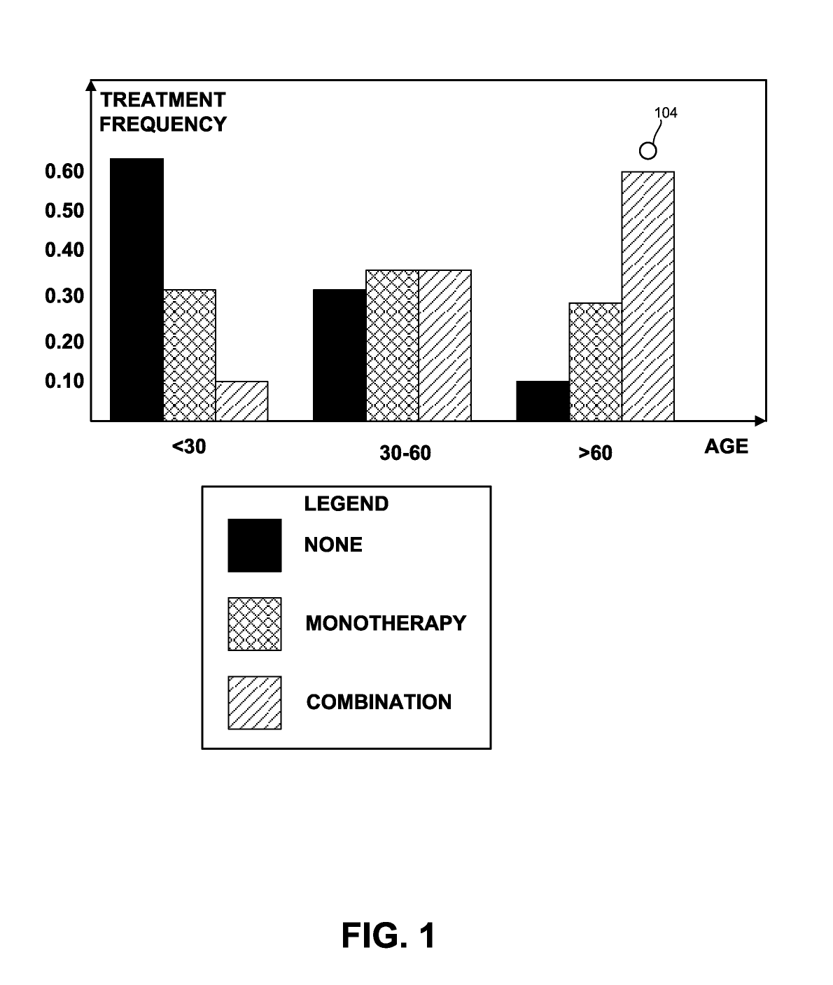

Referring now to FIG. 1, showing a graph of retrospective treatment analysis. FIG. 1 shows the conditional probability of treatment according to the patient's age, quantized into 3 bins. The treatment options are combined treatment, monotherapy treatment, or no treatment. It is seen that for patients under 30 years of age, usually no treatment is provided; for patients of 30-60 years in age, there is almost uniform distribution among the three options, and patients over 60 years of age usually receive combined treatment. The current patient's age group may be indicated by circle 104 to provide an indication to the patient's status within the particular group. As can be observed from the figure, few of the patients above 60 years receive treatment other than combination treatment. Assuming that the patient in question is over 60 years of age, this may cause the system (along with other features not shown here) to recommend combined treatment for this patient.

Another aspect of FIG. 1 relates to retrospective analysis of the data. Assume, for example, that the medical recommendation requires that he patient undergoes an expensive test before treatment is determined. Assume also that the distribution of the test result is more or less uniform within each age group. In such case, it makes sense to limit the recommendation to patients of 30-60 years of age, since for the other age groups the treatment is determined mainly based on the age, regardless of the result of the expensive test.

The analysis may be repeated every predetermined period of time, upon demand, upon the addition of at least a predetermined number of cases, or in accordance with any other criteria.

The retrospective analysis may comprise statistical calculation for determining the ranking of the different features, for example by their correlation with the assigned treatment. If one feature has higher correlation with the assigned treatment than another feature, then this feature will be ranked higher when determining the association of a case with a class. It will be appreciated that the graph of FIG. 1 also provides for prospective analysis, as it shows where the specific patient falls within the graph.

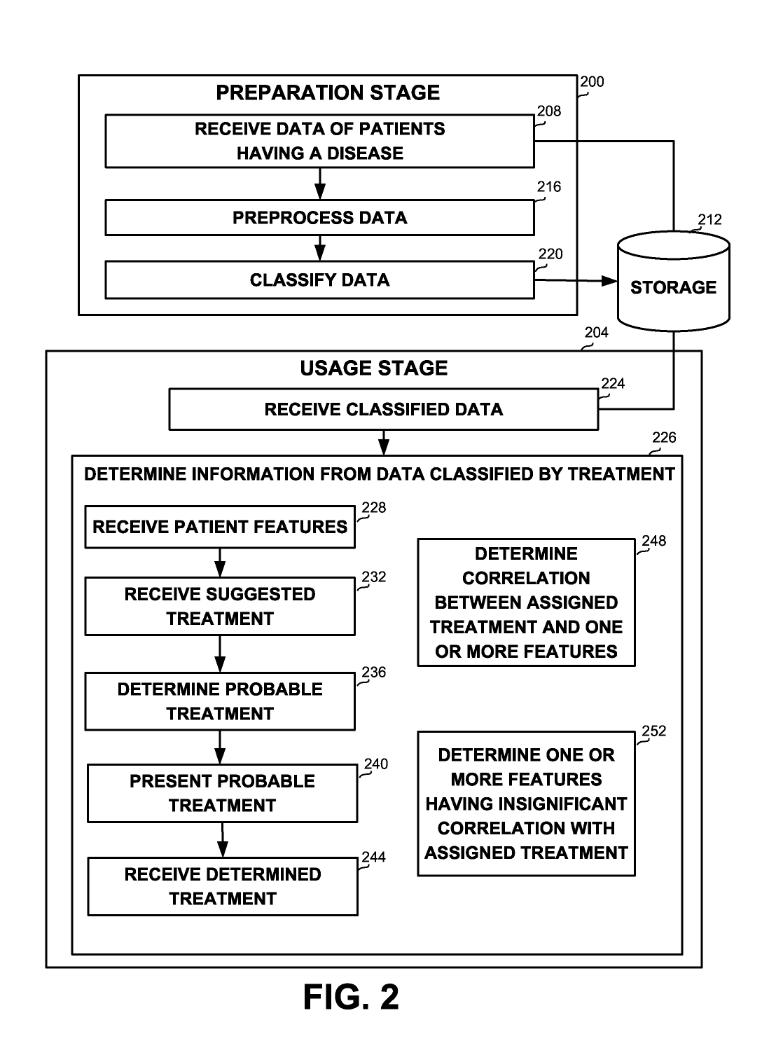

Referring now to FIG. 2, showing a flow chart of steps in a method for using a clinical decision support system.

The method comprises preparation steps 200 in which the data is processed, prepared for future used and stored, and usage steps 204 at which the data as processed and stored is used.

Preparation stage 200 comprises step 208 in which data related to patients having a particular disease may be received, wherein the data may comprise personal details, medical details and an indication for the treatment provided to each patient, or to the patient intentionally receiving no treatment. The data may be received from any source such as storage device 212, and in any format. The data may be obtained from treatment provided to the patients in a health care institute such as a hospital, a research center, or the like.

On optional step 216 the data may be preprocessed, including for example eliminating irrelevant data, filtering, transforming to a different format or the like.

On step 220 the data may be labeled into classes, such that each class is formed in accordance with a particular treatment, or treatment combination. The optionally preprocessed and labeled data may be stored, for example in storage 212 or in any other storage device. Step 220 may also comprise training a classifier for determining ranking or weights of features, upon which the association of cases with a particular class may be determined. However, the ranking, weight determination or any other criteria for associating cases with a class may also be determined or updated at a later stage, for example when additional records are received. Training the classifier may be performed based upon any relevant method, including but not limited to decision trees, K nearest neighbor, naïve Bayes classification, or the like.

Usage steps 204 comprises step 224 for receiving classified data, for example from storage 212, or from any other storage device in which the classified data has been stored.

On step 226, the data classified by the treatment is used to determine information, for example by a physician at a clinic, by a medical researcher, by an administrative researcher at the health institute, or the like. The usage may be performed in a variety of ways, optionally using the treatment reported for the cases.

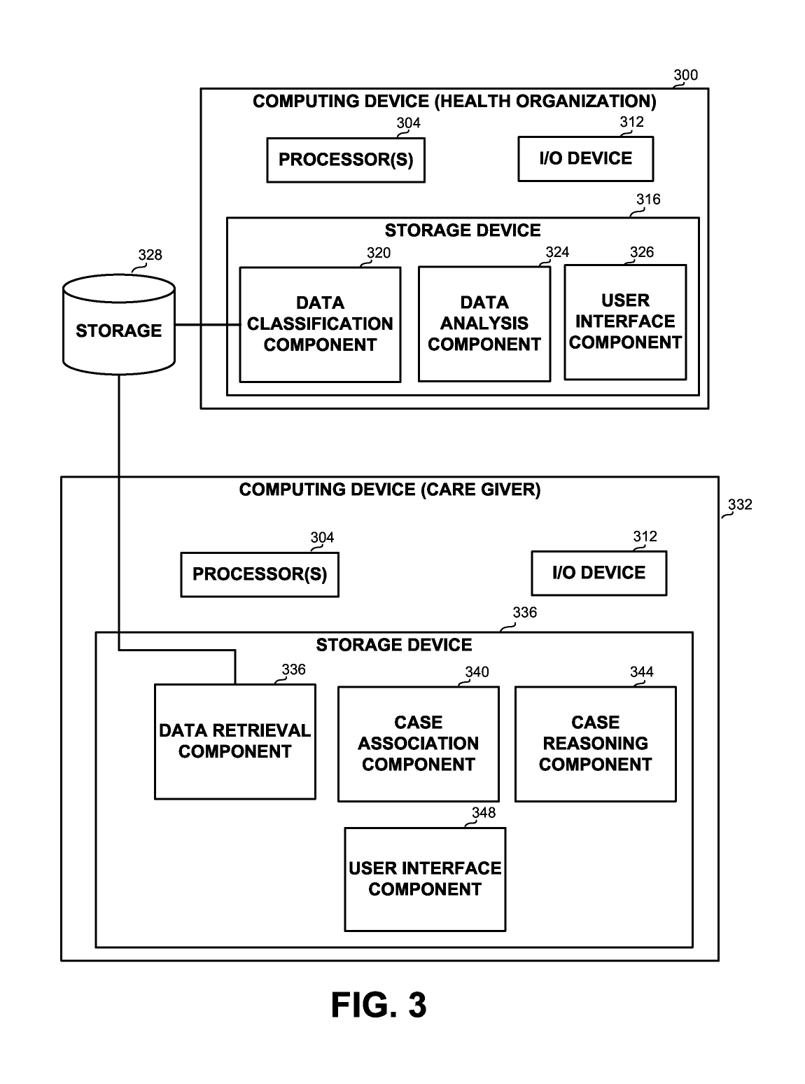

In some embodiments, the classified data may be used by a caregiver such as a physician caring for a patient. For example, on step 228 the patient details are received by an apparatus such as the apparatus detailed in association with FIG. 3 below, the details optionally including personal details such as age, gender, or the like, or medical details, such as symptoms, results of medical tests, diagnosis details, or the like.

On optional step 232, the caregiver may report or indicate to the apparatus the treatment he or she thinks is most appropriate for the specific patient.

On step 236 the probable treatment for the patient is determined from the labeled data, based upon, for example associating the patient details with the closest class into which the data is divided, and determining the treatment associated with that class. The association may use the weights or ranking assigned to different features determined on step 220.

The treatment associated with the class to which the case was classified represents the most probable treatment, i.e., the treatment most likely to be chosen by physicians in the institute upon which the data was collected would have assigned to a patient having such personal and medical features.

On step 240 the probable treatment as determined on step 236 is presented to the caregiver. In these embodiments in which the caregiver provided his or her suggestion on step 232, the probable treatment provides a “second opinion” so as not to influence the physician's initial suggestion. In some embodiments, the apparatus also provides the reasoning for the probable treatment, in natural language, in a graph, or in any other manner For example, the apparatus can present a graph similar to the graph of FIG. 1, output a text indicating that “for a person aged between X and Y the probable treatment is Z”, or the like. Such reasoning may provide the caregiver with some insight or understanding of which features were used in determining the probable treatment.

On step 244, the caregiver's determined treatment is reported to the apparatus. The determined treatment recommendation is thus received after the caregiver provided his or her suggested treatment, and after the apparatus suggested the probable treatment, so the determined treatment may take into account the two suggestions.

Other usage manners for the classified data are presented on step 248 and 252.

On step 248, correlation is determined between the provided treatment and a feature or a combination of features. For example, it may be determined that the MRI findings are the most important feature in treating particular disease, thus no treatment is to be assigned without performing the MRI scan.

On step 252, one or more features are determined which have insignificant correlation with the assigned treatment. For example, b-type natriuretic peptide tests are insignificant for identifying ventricular dysfunction in patients with coronary disease as shown in “Is b-type natriuretic peptide a useful screening test for systolic or diastolic dysfunction in patients with coronary disease? data from the heart and soul study” by Kirsten Bibbins-Domingo, Maria Ansari, Nelson B. Schiller, Barry Massie, Mary A. Whooley, published in the American Journal of Medicine, Volume 116, Issue 8, 15 Apr. 2004, Pages 509-516, ISSN 0002-9343, 10.1016/j.amjmed.2003.08.037 incorporated herein by reference in its entirety. These tests should therefore be eliminated, thus increasing the efficiency and resource consumption of health care. The disclosed method can thus be used for providing, enhancing, or refining treatment guidelines or recommendations.

Referring now to FIG. 3 showing a block diagram of components of an apparatus for clinical decision support.

The environment comprises a first computing device 300, associated with a health organization having a multiplicity of data records related to patients having a disease. First computing device 300 may comprise one or more processors 304. Any of processors 304 may be a Central Processing Unit (CPU), a microprocessor, an electronic circuit, an Integrated Circuit (IC) or the like.

Alternatively, first computing device 300 can be implemented as firmware written for or ported to a specific processor such as digital signal processor (DSP) or microcontrollers, or can be implemented as hardware or configurable hardware such as field programmable gate array (FPGA) or application specific integrated circuit (ASIC). Processors 304 may be utilized to perform computations required by computing device 300 or any of it subcomponents.

In some embodiments, first computing device 300 may comprise an input-output (I/O) device 312 such as a terminal, a display, a keyboard, an input device or the like to interact with the system, to invoke the system and to receive results. It will however be appreciated that the system can operate without human operation and without I/O device 312.

Computing device 300 may comprise one or more storage devices 316 for storing executable components, and which may also contain data during execution of one or more components. Storage device 316 may be persistent or volatile. For example, storage device 316 can be a Flash disk, a Random Access Memory (RAM), a memory chip, an optical storage device such as a CD, a DVD, or a laser disk; a magnetic storage device such as a tape, a hard disk, storage area network (SAN), a network attached storage (NAS), or others; a semiconductor storage device such as Flash device, memory stick, or the like. In some exemplary embodiments, storage device 316 may retain program code operative to cause any of processors 304 to perform acts associated with any of the steps shown in FIG. 2 above, for example classifying data.

Storage device 316 may comprise or be in communication with one or more storage areas 328 for storing patient data, classification data or other data associated with the apparatus. For example storage area 328 may comprise a multiplicity of medical cases grouped into at least two classes or groups such that each of at least two groups is associated with a treatment assigned to medical cases classified into the group.

The components detailed below may be implemented as one or more sets of interrelated computer instructions, loaded to storage device 316 and executed for example by any of processors 304 or by another processor. The components may be arranged as one or more executable files, dynamic libraries, static libraries, methods, functions, services, or the like, programmed in any programming language and under any computing environment.

In some embodiments the loaded components may include a data labeling component 320 for receiving multiple data records comprising details about patients having a particular disease, and dividing the data into classes in accordance with the treatment provided to the patients, as described in association with step 220 of FIG. 2, thus labeling the cases.

The loaded components may further comprise classifier generation component 324 for analyzing the labeled data and determining correlation between the assigned treatment and one or more features of the data records, in order to detect the features that best predict the assigned treatment, and optionally update the ranking, weights or other criteria. Classifier generation component 324 may also be used for determining features having low or no correlation with the provided treatment.

The loaded components may also comprise user interface component 326 utilized to receive input or provide output to and from the apparatus, for example receiving details of a patient, receiving requests for analysis, manipulating data, outputting analysis results, or the like.

The apparatus may further comprise a second computing platform 332, which a caregiver can use as a decision support system. Second computing platform 332 may comprise one or more processors 304 and I/O device 312 similar to processors 304 and I/O device 312 of first computing platform 300. Second computing platform 332 may also comprise a second storage device 336, similar to storage device 316 of first computing platform 300. Second storage device 336 may be loaded with data retrieval components 336 for retrieving the classified data from a storage area storing an instance of the classified data, such as data storage area 328 or another storage area.

The components loaded to second storage area 336 may comprise case association component 340 for receiving patient details such as personal or medical details, and associating the case with a particular class, so that the treatment associated with the class is suggested to be applied to the patient. The cases may be associated with classes based on the determined weights or criteria.

The components loaded to second storage area 336 may also comprise case reasoning component 344 for providing reasoning to the treatment suggestion, for example by detailing based on which features the particular case was assigned to the specific class and hence with the suggested treatment.

The loaded components may further comprise a user interface component 348 for receiving patient details, receiving suggested treatment from the care giver, suggesting to the caregiver the treatment assigned to cases in the class with which the case was associated, or the like.

In some embodiments, the apparatus may be designed so that the recommended treatment is presented to the caregiver only after the caregiver has given his or her suggestion. In some embodiments, the apparatus may store indications to cases in which the caregiver has changed his mind about the treatment to be provided due to the probable treatment as provided by the system.

It will be appreciated that the disclosed method and apparatus can also be used by a patient seeking a second opinion for treatment in addition to the opinion provided by his or her caregiver. The patient can enter his own details, including personal and medical details, and would receive an indication to what other doctors would have assigned under such circumstances.

It will be appreciated that the disclosed apparatus can also be implemented as a client-server system, in which each caregiver and a user using the analysis capabilities of the system use a client system, wherein the server and all clients access a shared database of the classified cases.

The disclosed method and apparatus provide for classifying a multiplicity of cases associated with a particular disease into classes or groups based on the assigned treatment. The classification can then be used either for exploring the process of taking the medical decisions by the medical staff, or to provide a caregiver with a treatment recommendation based on what other physicians would have assigned to such case.

The flowchart and block diagrams in the figures illustrate the architecture, functionality, and operation of possible implementations of systems, methods and computer program products according to various embodiments of the present disclosure. In this regard, each block in the flowchart and some of the blocks in the block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, any non-transitory computer-readable medium, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the

Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A computer-implemented method performed by a computerized device, comprising:
receiving a multiplicity of medical cases associated with a disease, each of the multiplicity of medical cases comprising medical features and assigned treatment, wherein the medical cases are divided into at least two groups such that each of the at least two groups is associated with a treatment assigned to medical cases classified into the group; and
using the multiplicity of medical cases as divided into the at least two groups, to determine information.

2. The computer-implemented method of claim 1, wherein the determined information comprises a probable treatment to be suggested for a patient having the disease and reporting the probable treatment to a caregiver.

3. The computer-implemented method of claim 2, further comprising receiving a suggested treatment from the caregiver prior to reporting the probable treatment to the caregiver.

4. The computer-implemented method of claim 2, wherein determining the suggested treatment comprises:
associating a case with one of the at least two groups; and
suggesting the treatment associated with the group to be provided to the patient.

5. The computer-implemented method of claim 4, wherein the treatment is a decision not to treat the disease.

6. The computer-implemented method of claim 4, wherein associating the case with one of the at least two groups is performed in accordance with predetermined ranking or weights.

7. The computer-implemented method of claim 1, wherein the determined information comprises a feature having high correlation with the assigned treatment.

8. The computer-implemented method of claim 1, wherein the determined information comprises a combination of at least two features having high correlation with the assigned treatment.

9. The computer-implemented method of claim 1, wherein using the multiplicity of medical cases comprises determining a feature having low correlation with the assigned treatment.

10. The computer-implemented method of claim 89 wherein the feature is associated with a medical test to be eliminated.

11. The computer-implemented method of claim 1, further comprising generating a classifier for associating at least one of the multiplicity of medical cases into one of the at least two groups.

12. The computer-implemented method of claim 11, wherein generating the classifier comprises determining feature ranking or weights.

13. The computer-implemented method of claim 11, wherein generating the classifier is performed using a method selected from the group consisting of:
decision trees, K nearest neighbor, and naïve Bayes classification.

14. An apparatus having a processing unit and a storage device, the apparatus comprising:
a storage device storing a multiplicity of medical cases associated with a disease, each of the multiplicity of medical cases comprising medical features and assigned treatment, wherein the medical cases are divided into at least two groups such that each group of the at least two groups is associated with a treatment assigned to medical cases classified into the group.

15. The apparatus of claim 114, further comprising:
a data retrieval component for retrieving the multiplicity of medical cases as classified into the at least two groups; and
a case association component for associating a case of a patient having the disease with a group of the at least two groups, and suggesting the treatment associated with the group to be provided to the patient.

16. The apparatus of claim 11415, further comprising a case reasoning component for providing reasoning for the suggested treatment.

17. The apparatus of claim 11415, further comprising a user interface component for receiving patient details, and suggesting to a caregiver a treatment assigned to cases in the class with which the case was associated.

18. The apparatus of claim 114, further comprising a classifier generation component for determining a feature or a combination of at least two features having high correlation with the assigned treatment.

19. The apparatus of claim 114, further comprising a classifier generation component for determining a feature having low correlation with the assigned treatment.

20. The apparatus of claim 19 wherein the feature is associated with a medical test to be eliminated.

21. The apparatus of claim 114, further comprising a labeling component for dividing the multiplicity of medical cases into the at least two groups.

22. A computer program product comprising:
a non-transitory computer readable medium;
a first program instruction for receiving a multiplicity of medical cases associated with a disease, each of the multiplicity of medical cases comprising medical features and assigned treatment, wherein the medical cases are divided into at least two groups such that each of at least two groups is associated with a treatment assigned to medical cases classified into the group; and
a second program instruction for using the multiplicity of medical cases as divided into the at least two groups, to determine information, wherein said first and second program instructions are stored on said non-transitory computer readable medium.
